(19) United States
(12) Patent Application Publication
(10) Pub. No.: US 2019/0012615 A1
(43) Pub. Date: Jan. 10, 2019

(54) System and Apparatus for the Display and Selection of Listings and Splits

(71) Applicant: BROKER GENIUS, INC., FAR ROCKAWAY, NY (US)

(72) Inventors: Shmuel Sherman, Valley Stream, NY (US); Jim McGowan, Flemington, NJ (US)

(21) Appl. No.: 16/031,886

(22) Filed: Jul. 10, 2018

Related U.S. Application Data
(60) Provisional application No. 62/530,833, filed on Jul. 10, 2017.
(60) Provisional application No. 62/530,831, filed on Jul. 10, 2017.
(60) Provisional application No. 62/530,834, filed on Jul. 10, 2017.
(60) Provisional application No. 62/530,836, filed on Jul. 10, 2017.

(51) Int. Cl. G06Q 10/02; G06F 17/30

(52) U.S. Cl. CPC G06Q 10/02; G06F 17/30241; G06F 17/30061

(57) ABSTRACT

By way of non-limiting implementation, a system is described for displaying linked inventory objects within a virtual venue map. In one particular configuration, at least one database is configured to store a plurality of data values corresponding to one or more event access credentials, wherein at least one data values associated with each event access credential includes a reference to one or more additional event access credentials linked to a given event access credential and at least one data value that provides a unique location identifier. The system also includes a processor having a memory and configured by code to access the virtual venue map from one or more remote map servers, wherein each virtual map includes a plurality of unique location elements. The processor is further configured to associate each access credential with one of the plurality of unique location elements of the virtual venue map. Each access credential that is linked to another access credential is identified, such that the processor is configured to generate a visual marker that identifies each linked group of access credentials on the display in response to a user selection.

### CROSS REFERENCE TO RELATED APPLICATIONS

This Application claims priority to U.S. Application No. 62/530,833, filed on Jul. 10, 2017 and herein incorporates by reference the same. This Application claims priority to U.S. Application No. 62/530,831, filed on Jul. 10, 2017 and herein incorporates by reference the same. This Application claims priority to U.S. Application No. 62/530,834 filed on Jul. 10, 2017 and herein incorporates by reference the same. This Application claims priority to U.S. Application No. 62/530,836, filed on Jul. 10, 2017 and herein incorporates by reference the same. Each of the foregoing Applications are incorporated by reference as if presented in their entirety.

### FIELD OF THE INVENTION

The present described systems, methods and computer products are directed to receiving, manipulating and generating visualizations of event venue access credentials for the purpose of optimizing computer-based event ticket sales.

### BACKGROUND OF THE INVENTION

Event tickets are often sold in groups, called “splits” (https://support.vividseats.com/support/solutions/articles/1000212794-what-are-splits-). A “listing” is a generic term for posting a group of tickets for sale, typically in contiguous seats in a stadium. For instance, if a user wishes to purchase four seats for a football game, one may purchase either (a) a listing of four tickets for consecutive seats, or (b) a four-seat subset or “split” of a listing containing more than four seats. Large splits may sell for a high per-seat price relative to small splits if the supply of large splits is limited relative to the market demand. This is simply due to the fact that large groups of people purchasing tickets would prefer to sit together. Therefore, it is advantageous for a seller of such listings to place limits on the allowable splits. These limitations may change over time in a complex strategy a ticket seller implements to balance, inter alia, the added value of the contiguous seats versus the market demand, competitive seats, and the time to the event.

The availability of listings with greater than two tickets is important to potential purchasers, who would like to narrow their search to the split size of their liking. The seller would also like to optimize the availability of large listings. For instance, if a six tickets listing is available, a seller would prefer not to make the middle two seats available as a single split, because, on balance, the seller will then have two listings of two tickets each. By only allowing a split of two on the outer seats, the seller will then have a four-ticket listing remaining, which has the flexibility of selling as a four-ticket split or pair of two-ticket splits. The purchaser will typically prefer to middle two seats on the chance that the others will remain unsold, giving some additional room to the purchaser. Thirty days from a popular event a seller is unlikely to allow the two center seats to be purchased separately or will charge a considerable premium for them. Hours before an event with significant four ticket splits available in the area, a seller is likely to allow the middle two seats to sell.

In a typical purchasing scenario, a user is shown a map of a venue with a set of seats, called a venue map. In most current venue maps in the market, the individual seats available are shown, and in some cases a user may only select a seat in pairs, provided a contiguous seat is available. However, the does not exist in the art a mechanism where listings available as splits are rendered in the venue map.

Thus, it would be advantageous to provide a credential access management system that allows for the accurate display, visualization, and analysis of access credential listings and available splits thereof.

### SUMMARY OF THE INVENTION

In a particular implementation of the systems and methods described herein a venue map is generated that renders visual indications of available seats. In addition, available listings are made visually distinct within the virtual map such that the user is able to ascertain which particular seats are available under a given set of market conditions. Further, the available splits within listings are also generated and provided to an end user in visually distinct way, so as to permit users to easily identify such listings.

By way of non-limiting implementation, a system is described for displaying linked inventory objects within a virtual venue map. In one particular configuration, at least one database is configured to store a plurality of data values corresponding to one or more event access credentials, wherein at least one data values associated with each event access credential includes a reference to one or more additional event access credentials linked to a given event access credential and at least one data value that provides a unique location identifier. The system also includes a processor having a memory and configured by code to access the virtual venue map from one or more remote map servers, wherein each virtual map includes a plurality of unique location elements. The processor is further configured to associate each access credential with one of the plurality of unique location elements of the virtual venue map. Each access credential that is linked to another access credential is identified, such that the processor is configured to generate a visual marker that identifies each linked group of access credentials on the display in response to a user selection.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating particular elements according to one embodiment of the present invention.

FIG. 2 presents a flow diagram detailing steps taken in one configuration of the access credential management system.

FIG. 3 presents a collection of modules detailing the operative functions of the access credential management system according to one configuration of the present invention.

FIG. 4 presents a graphical user interface detailing operative functions of the access credential management system according to one configuration of the present invention.

### DETAILED DESCRIPTION OF CERTAIN EMBODIMENTS OF THE INVENTION

This application herein incorporates by reference U.S. patent application Ser. No. ______ and titled “Default Venue Maps” filed concurrently herewith and having attorney docket number 10153/006063-US1, U.S. patent application Ser. No. ______ and titled “Automated Comparable-Based Pricing Using Non-Zero-Difference Comparables” filed concurrently herewith and having attorney docket number 10153/006065-US1, U.S. patent application Ser. No. ______ and titled “Various Methods for Displaying Venue Information on a Venue Map” filed concurrently herewith and having attorney docket number 10153/006066-US1. Each of the foregoing Applications are incorporated by reference as if presented in their entirety.

By way of overview and introduction, various embodiments of the systems and methods described herein are directed a computer system configured to generate venue (e.g. a pre-determined location for the commencement of an event) maps that provide visual indications of available seats within venue. In addition, available listings are shown by a display device in a visually distinct manner so as to indicate various data features (e.g. price, availability) specific to that seat or collection of seats. As used herein, venue maps inform a ticket purchaser of the location of the seat associated with one or more tickets. Thus, a venue map is a geographical interpretation of an event venue showing such information as the seats, rows and sections comprising an event space (e.g. a stadium). For example, a seat or venue map might show one or more contiguous set of seats in a given section. Here, a section is a contiguous set of rows of seats, typically separated by an aisle from other sections. However, such simple geographic representation, when transmitted to remote users (such as internet users) does not allow for a full appreciation of the particular advantages or disadvantages of a given seat in a particular venue.

It should be understood that the described optimization and transformation operations with respect to the venue map, as well as the visualization of listings and splits, detailed herein can be applied to a multitude of purposes. However, for ease of explanation and demonstration, the foregoing explanations are directed to optimizing the sale and purchase of tickets to events. Specifically, the provided examples concern the analysis and visualization of inventory (e.g. ticket listings) and splits (e.g. items that are to be sold together). While such information may be advantageously rendered for a ticket pricing application, a pricing analysis application, a sales tracking application, a sales prediction application, or other access credential purpose, such approaches are not intended to limit the scope of the disclosure herein.

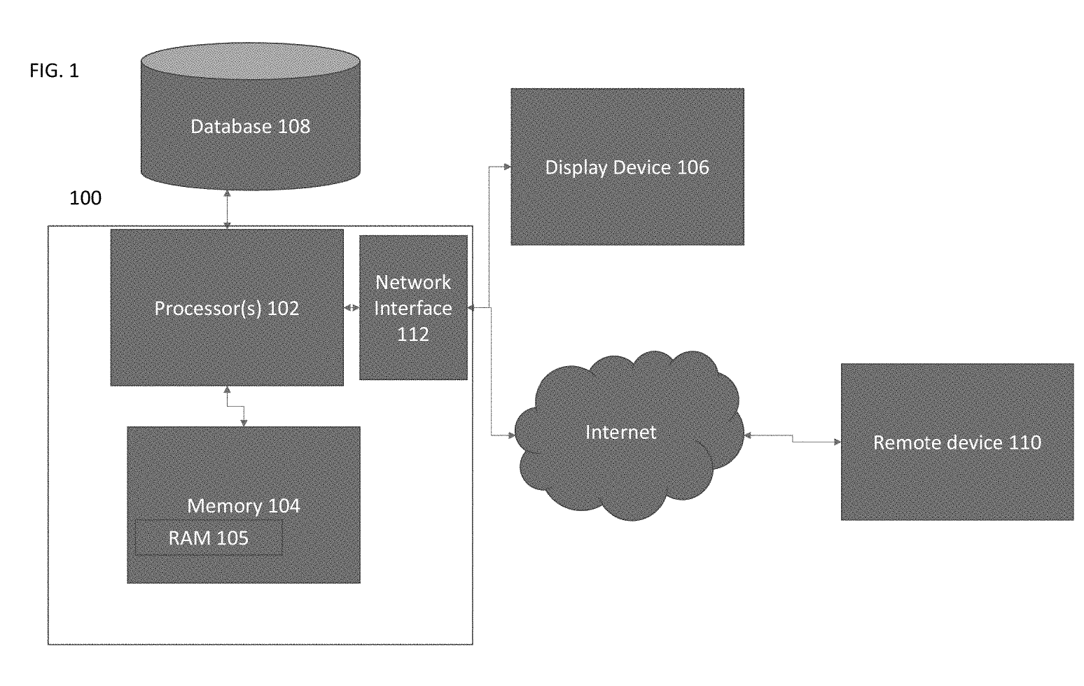

Turning now to FIG. 1, a computer system 100 is provided to access, evaluate and transform data. In one or more configurations, the computer system 100 is composed of one (1) or more processors 102 configured to execute code residing therein. For instance, in one implementation, the computer system is a standard computing device such as, but not limited to, commercially available computing device. For example, the processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, the processor 102 can comprise a single processor, multiple discrete processors, a multi-core processor, or other type of processor(s) known to those of skill in the art, depending on the particular embodiment. In a particular example, the processor 102 executes software code on the hardware of a custom or commercially available cellphone, smartphone, notebook, workstation or desktop computer configured to receive data either directly from one or more memories or data storage devices, or indirectly through a communication linkage to one or more memories or data storage devices, such as database 108.

The processor 102 is configured to execute a commercially available or custom operating system, e.g., MICROSOFT WINDOWS, APPLE OSX, UNIX or Linux based operating system in order to carry out instructions or code.

In one or more implementations, the processor 102 is further configured to access various peripheral devices and network interfaces. For instance, the processor 104 is configured to communicate over the internet with one or more remote servers, computers, peripherals or other hardware using standard or custom communication protocols and settings (e.g., TCP/IP, etc.).

The processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 102 provides for the storage of application program and data files. One or more memories provide program code that the processor 102 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of the processor 102 provides for storage of an application program and data files when needed.

In one implementation, each element provided in FIG. 1 is configured to communicate with one another through one or more direct connections, such as though a common bus. Alternatively, each element is configured to communicate with the others through network connections or interfaces, such as a local area network LAN or data cable connection. In an alternative implementation, the display device 106, remote computer 110, processor 102, and database 108 are each connected to a network, such as the internet, and are configured to communicate and exchange data using commonly known and understood communication protocols.

In a particular implementation, the processor 102 is a computer, workstation, thin client or portable computing device such as an Apple iPad/iPhone® or Android® device or other commercially available mobile electronic device configured to receive and output data to or from database 108, display device 106 and/or remote computer device 110. Here, the processor 102 communicates with a display device 110 for displaying data as well as input hardware to permit a user to access information, and to send commands and/or instructions to the processor 102 and the color measurement device. In one or more implementations, the display device 106 is a screen, monitor, display, LED, LCD or OLED panel, augmented or virtual reality interface or an electronic ink-based display device.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

As shown, memory 104 and persistent storage 108 are examples of computer-readable tangible storage devices. A storage device is any piece of hardware that is capable of storing information, such as, data, program code in functional form, and/or other suitable information on a temporary basis and/or permanent basis. In one or more embodiments, memory 104 includes random access memory (RAM) 105. RAM 105 may be used to store data such as the venue data in accordance with the present invention. In general, memory 104 can include any suitable volatile or non-volatile computer-readable storage device. Software and data are stored in persistent storage 108 for access and/or execution by processors 102 via one or more memories of memory 104. With respect to remote device 110, for example, software and data are stored locally on the remote computing system.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 112, in these examples, provides for communications with other sub-systems or devices. In an embodiment, communications unit 112 may provide appropriate interfaces to the Internet or other suitable data communications network to connect to one or more servers, resources, API hosts, or computers. In these examples, communications unit 112 may include one or more network interface cards. Communications unit 112 may provide communications through the use of either or both physical and wireless communications links.

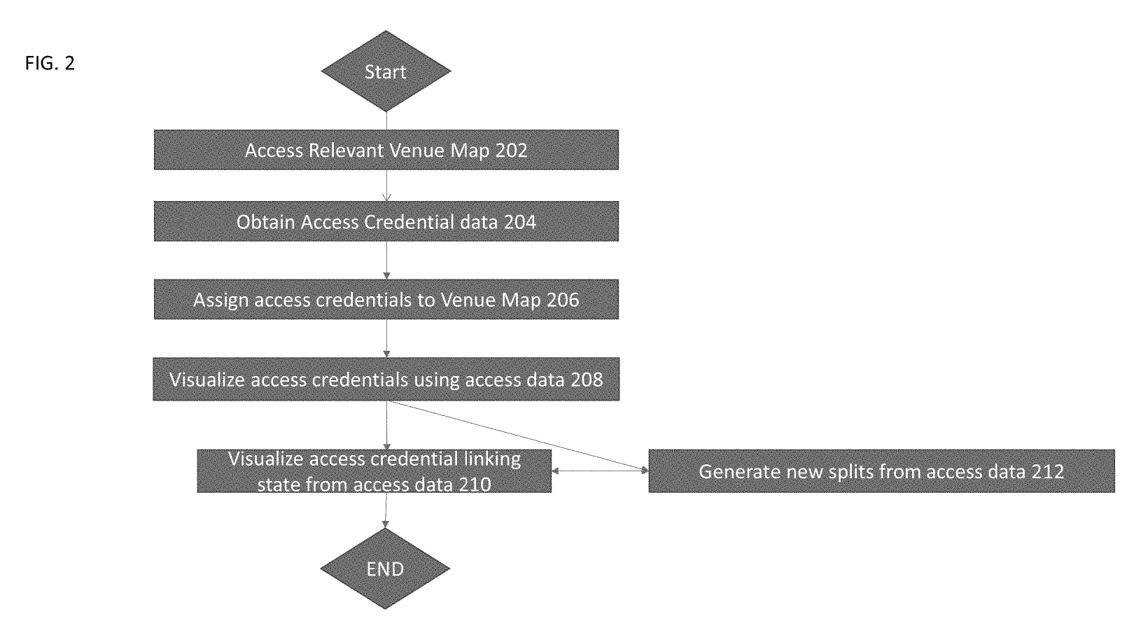

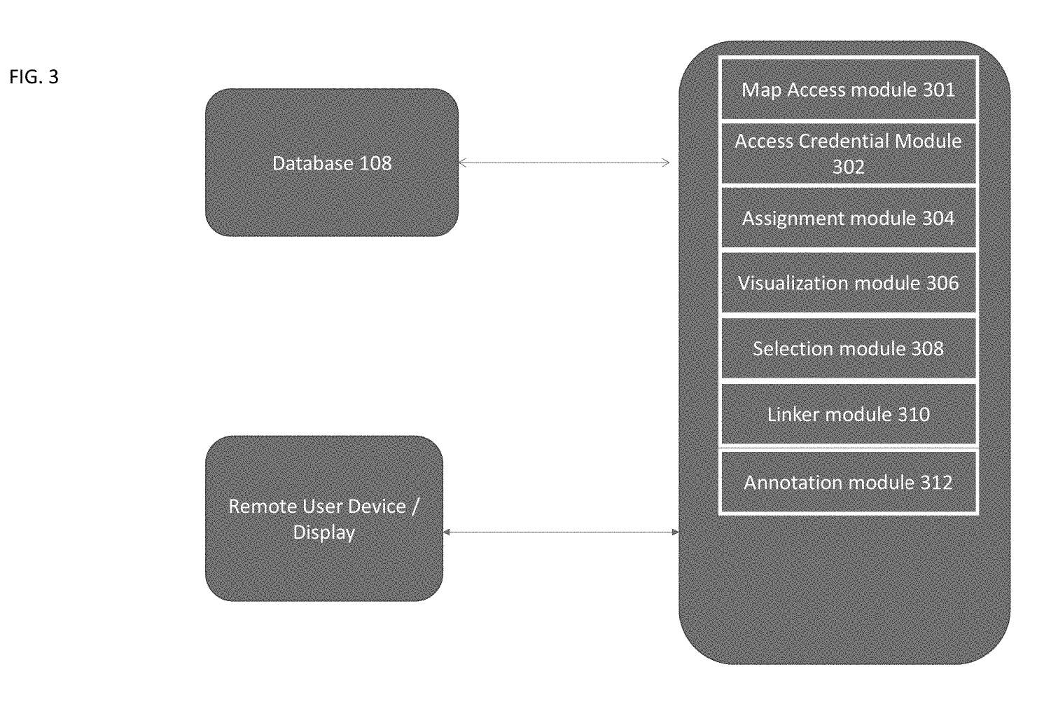

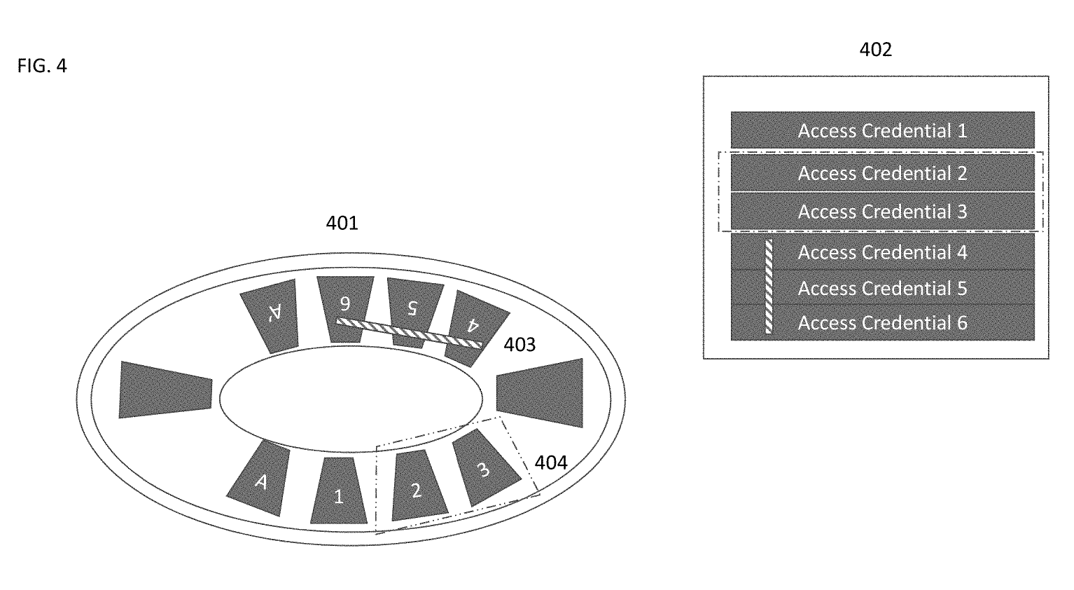

With reference to FIGS. 2 and 3, a system is described for generating, displaying or visualizing linked inventory objects within a virtual venue map. In a particular, non-limiting configuration, an access credential inventory management system utilizes one or more processors 102. As shown, a processor 102 having a memory 104 that stores one or more modules (as shown in FIG. 3) is configured to access a virtual map of the given event. For example, as shown in step 202 of FIG. 2, the processor 102 is configured by the map accesses module 301 to access a virtual map. Here, the map access module 301 includes a collection of one or more submodules that configure the processor 102 to access a local or remote storage location, query a remote resource with the desired venue information, formatting and or other additional operating functions. For example, in one or more configurations, the venue map is accessed from a remote web host or server and is received as a data stream, file, binary string, JSON object, vector data, image data or another data format. Upon receipt by the processor 102, the event venue map (such as map 401 of FIG. 4) can be displayed on the display device 106 or stored in temporary or working memory for further processing. In yet a further configuration, the venue map(s) received by the processor 102 include at least real-time inventory data. In a further arrangement, the venue data also includes historical data, a plurality of unique seats or locations within the venue, GIS data, elevation data, cross-linked or directly linked image data. Venue data in real-time, is presented to a user on a user interface displayed by the display device or remote device.

The processor 102 is further configured though one or more modules to access or obtain access credential inventory information. Such a system includes at least one database configured to store credential inventory data, wherein the credential inventory data includes at least a data object corresponding to each of the plurality of access credentials, wherein the data object includes a value indicative of the availability of the associated access credential. In a further arrangement, the access credential data include values indicative of the location of a given access credential and the price of a given access credential.

Through one or more additional modules, the processor is also configured to receive from one of the one or more remote databases the credential inventory data. As shown in step 204, the processor 102 configured by the access credential module 302 is configured to retrieve from a remote database (e.g. database 108) access credential data. In one or more implementations, the access credential data includes at least a data object corresponding to each of the plurality of access credentials, wherein the data object includes a value indicative of the availability of the associated access credential. In a further implementation, the data object includes references to one or more additional access credentials that are linked to a given access credential.

The access credential data is obtained in one or more configurations by accessing a primary event vendor. For example, the processor 102 is configured by one or more submodules of the access credential module 302 to initiate a remote connection to one or more vendors of the access credential and receive information relating to the current inventory of access credentials as well as information relating to each access credential.

As used herein, the one or more features of the access credential data can include the price, location, date, time of the event, particular seat or assigned location, additional perks (free parking-VIP access) and other information associated with a given event.

Continuing with the flow diagram of FIG. 2, the processor 102 is configured by an assignment module 304 to assign, using the features associated with each of the plurality of access credentials, each of the plurality of access credentials to one of the plurality of sections of the virtual map. As shown in Step 206, the access credential data features corresponding to a particular location (e.g. seat) are used link the given access credential to the specific section of the venue map.

In one particular implementation, the venue map has pre-defined sections. In this arrangement the venue itself provides both the venue map as well as the data features associated with each of the access credentials that indicates a location using the pre-defined sections. However, in circumstances where there is no pre-defined sections of the venue map, the corresponding access credentials will not have section or seat level feature data. In this arrangement the assignment module 304 is configured to assign each of the access credentials to a defined section of the venue map. For example, using historical data relating to the relative location of seat with respect to the featured event (e.g. the main stage of a concert) access credentials can be grouped based on seat data into section. Likewise, pricing data can be used to group access credentials. For example, where price of the access credentials can be used to determine the relative rarity or desirability of a given access credential, such pricing can be used to group similarly priced access credentials. In further iterations, both price and historical data are used to group access credentials into a section. Likewise, survey data (such as a third-party resource) is used to locate a particular access credential within a venue such that all access credentials that are placed within a similar location are deemed to be in a given section.

In a further implementation, the processor 102 is configured to generate a visual marker for each unique location within the venue map. For example, each seat within the venue is assigned the same default indicator (such as a marker, chevron, geometric shape, or the like).

Then, the processor 102 is configured by a visualization module 306 to alter the appearance or color of each unique location (e.g. seat or section) as a function of the percentage of access credential available within a given section, there status, price or linking state. By way of non-limiting example, the processor 102 is configured by the visualization module 306 to generate a visual marker and assign each seat or sector a default color value. In one implementation, the default color is a RGB color value.

As shown in step 208, the access credential information provides a value for each of the access credentials that is indicative of the relative amount of access credentials still available within a given section. For example, because the total number of access credentials are known, and each access credential includes a data value indicating its availability, this data can be used to determine on seat by seat, or section, by section basis, the relative availability of each section.

In one or more further implementations, the visualization module 306, or one or more submodules thereof, configure the processor 102 to generate one or more metrics relating to the access credential dataset and display the metrics along with the virtual map.

In one particular configuration, the access credential data received from the database 108 includes a reference to one or more additional event access credentials linked to a given event access credential. For example, where the vendor of a collection of tickets wishes to sell the tickets as a group, such tickets are linked. For example, using the data in the access credential dataset, the processor is configured by the linking module 310 to link each identified access credential. Here, each access credential that is linked to another access credential is identified, such that the processor 102 is configured to generate a visual marker that identifies each linked group of access credentials on the display in response to a user selection. For example, in one particular configuration, the processor 102 is configured by the visualization module 306 to generate a visual indication that highlights the linked nature of the access credentials by generating a wire frame or similar outline that highlights a collection of seats as being linked to one another. In a further implementation, the processor 102 is configured to change the area or background surrounding a collection of access credentials. In one or more further implementations, the processor 102 is configured to render the unique locations of the event venue map in a different style so as to indicate that such as a change in tint, shading or color, or visual pattern. In yet a further implementation, the processor 102 is configured to alter the visual markers representing unique locations within the venue map in response to updates indicating that the locations have been linked or unlinked, such as a change in the visual icon used to indicate a seat, including the tinting, shading, size or shape of said icons. However, where the processor 102 is configured to identify linked access credentials, the processor provides updates to the rendering of the venue map (401) to provide a connecting element such as a line drawn between the icons representing each seat, or a distortion of the elements so as to render them connected, or a replacement of the individual icons with a group icon, such as a bar to represent a grouping of multiple seats, or any combination of the above, or any other visual distinction that distinguishes the seats in one listing from another.

In one or more further implementations, both a venue map and a listing of each access credential is provided as in FIG. 4. As shown, different unique locations (e.g. A and A′) are provided in a virtual map 401. Here, the unique location can refer to an individual seat, or a section. Likewise, each access credential can be displayed as a list of access credential, as shown in display window 402.

In one or more configurations, the visualization module 306 configures the processor 102 to render on a display 106, the linked access credentials (e.g. splits) according to any of the approaches, separately or in combination, described herein. For instance, a listing may be distinguished by a wire frame as described herein, and each available split may be indicated by a different color, shape or shading.

It will be appreciated by those possessing an ordinary level of skill in the requisite art that linked access credentials (e.g. available splits) may overlap one another. For instance, a collection or grouping of linked access credentials may include one or more sub-groupings, such that a linked group can be sold in smaller or larger groups, so long as the defined groupings associated with the particular access credential are followed. For example, seats 1-3 of FIG. 4 can be a linked group. However, seats 2-3 comprise a sub-grouping that is permitted for sale based on certain conditions. Thus, depending on the data associated with the linked access credentials, one or more rules may be implemented by a suitably configured processor (102) to determine, as a function of time, location, and/or demand that the linked access credentials should be de-coupled, or segmented into smaller groupings of linked access credentials as shown in step 212. By way of non-limiting example, a user may receive data indicating (which can, in one implementation, be the same as the vendor) a listing of six contiguous seats (e.g. unique locations within a venue) numbered consecutively from 1 to 6. In one or more implementations, the processor 102 configured by a linker module 310 evaluates the collection of unique locations and corresponding access credentials and generates one or more proposed divisions of the lined access credential group. For example, where the linked access credential group includes six (6) access credentials, the processor 102 is configured to generate the following combinations of access credentials that will be offered for sale. For example, with particular reference to FIG. 4, each of the following bifurcations or divisions (such as division 404 shown in dashed line) of the original control group can be sold for different prices depending on the data features associated with each group, such as the number of access credentials within the group, the location of each access credential (e.g. an isle or inner seat).
1-6
1-5, 6
1, 2-6
1-2, 3-6
1, 2-5, 6
1-4, 5-6
1-4, 5, 6
1, 2, 3-6

Different combination of bifurcations or divisions are also envisioned depending on the particular configuration of the venue. For example, as the time to the event approaches, the processor 102 is configured to automatically unlink all access credentials such that the access credentials may be sold individually. Here, the processor 102 is configured to determine or receive a timing threshold. Upon determining that the timing threshold has been exceeded, the processor automatically unlinks each of the linked access credentials.

In response to the bifurcations or divisions generated by a processor 102 configured by the linker module 310, one or more additional visualizations of the linked access credentials are applied to the virtual venue maps. Here, the visualization module 308 is configured to generate one or more alternative or additional visual indications that instruct a user that the given or selected linked access credentials may be bifurcated or divided in to smaller, more marketable groupings. For instance, the entire grouping may have an additional visualization marker applied to the collection or grouping of linked access credential that provides a text notification indicating “single seats allowed.” Alternatively, each bifurcation or division may be assigned a numerical value. Here, all of the linked access credentials are given an assigned value. In one implementation, the assigned value is indicative of the number of additional access credentials necessary to purchase to obtain a given access credential. For example, each of the bifurcations or divisions of the linked group are labeled with a “1” icon, which indicates that the listing allows splits down to a single ticket. Conversely, the visualization processor is configured to generate a “1” icon in a slashed circle, or equivalently a grayed-out “1” icon. Such modified icons can be used to indicate that a given value (e.g. single ticket) splits are not allowed.

In one or more further configurations, the processor 102, upon receipt of a user input (such as, but not limited to, a keystroke, click, touch, mouse-over, or similar action) relating to a given unique identifier in the virtual map, the virtual map may be redrawn or re-rendered to show all the listings that seat may be part of, by, for instance, showing overlapping, semi-transparent background shading. For example, the processor 102 is configured to alter one or more pixels or vectors associated with the venue map to provide a visual indication that a given unique location (e.g. seat) and one or more neighbor (such as on either side of the given seat) are part of a four-ticket split. Alternatively, multiple lines over the seats may show the extent of all permissible combinations. For example, the visualization module 308 configures the processor 102 to draw a collection of lines or other geometric shapes on the venue map so as to link visually the access credentials that are linked according to the data set. Alternatively, a series of different colored bars (shown as 403) or lines may be drawn or rendered over the seats and used to show which seats may be grouped together.

For ease of explanation, a series of bars will be used in an example herein. In one particular implementation, the processor 102 receives from a user (either remote or local) a selection of one or more locations within a virtual venue map. For example, upon the user selects a unique location in the venue map. In response, a request is generated and sent to the processor 102, where the request includes the selected unique location, requesting user information, and other metadata that may be commonly associated with such a selection. For example, upon receipt of a request from a user, the venue map is drawn such that the each access credential provided within the group of linked access credentials is highlighted. In a further implementation, the venue map is composed of a collection of individual visual elements that are addressable. In this arrangement, the processor 102 is configured by the visualization module to generate a replacement icon or indication and exchange each visual marker representing a unique location referenced by each of the linked access credentials such that the entire venue map does not need to be updated. In this arrangement, only the relevant unique identifiers referenced by the access credential data are modified. In yet a further implementation, the processor is configured to alter a unique identifier based upon its selection, such as changing the tint, shading, color, etc., as described herein. However, it will be appreciated that selection of permissible splits is more complicated and not obvious in view of the present approaches, since such permitted splits may overlap in many combinations. In the bar example below, one may simply click a one or the plurality of bars indicating visually which seats are included, causing the selected seats to be selected, visually highlighted, or re-rendered.

Alternatively, the processor 102 is configured by a selection module 308 to receive a data stream from a user interface (either from a local user, or a remote user). Here, the data stream represents a user-initiated action (such as a click) on a single unique location) as well as the coordinates traversed while the users moves a selection window to capture more unique locations. By way of example, the user selects a single seat (e.g. a unique identifier) and drags a selection device (such as a mouse) left or right to include more seats in the selection. As each seat is dragged over, the processor 102 is configured to send, in real-time, updates to the virtual map so that the adjoining seats that have been “dragged over” are re-rendered or exchanged for icons that provide a visual marker or distinction that indicates the unique location is part of a linked group of access credentials. Thus, in one arrangement, only permissible combinations of unique locations (e.g. seats) would result in a highlight change. For instance, if one clicks on or near seat 1, of FIG. 4, seat 2 may also be highlighted. By dragging to seat 3, there is no change. Then dragging further to seat 4 will cause 1, 2, 3 and 4 to be highlighted. Releasing the drag may yield a visual distinction that is applied to all of the group. Grabbing the edge of the visual distinction or the region with a visual distinction and dragging may increase or decrease the number of selected seats, in accordance with the permissible splits.

Alternatively, one may “lasso” select a region by highlighting with a mouse and dragging over a region of the display, in order to visually segment a region. Such a lasso can be used, inter alia, to select a listing or a split within a listing. The selection may, inter alia, include the largest listing or split available within the region, and may either include partially highlighted seats or exclude them.

Rendering Trigger

In further detail, the visual distinctions indicating listings, splits or permissible splits may be made, inter alia, when the venue map is rendered, or any point thereafter, or due to some preceding event or action by the user, such as a mouse-over, or selection of some subsection of the venue, or some change in the market or update to the dataset. The onset or offset of a visual distinction may be animated or change over time. For instance, a background shading change may be phased in gradually. A sequence of animations may be used in conjunction with the rendering, such as a background shading expanding from a geometric center of a listing, and, having reached the boundaries of the listing, convert to a line that frames the listing. Many variations are possible.

Other triggers may include, among other things, a change in listing status from available to unavailable, a change in price, a change in permissible splits, to indicate that the available split sizes have become more or less “rare”, or some other computed metric, such as an indication that the price of a listing or split has been calculated to be desirable or undesirable given the comparable listings, either for the event, for similar events either in other venues or in historical data related to sales of tickets within that or other venues.

Those possessing an ordinary level of skill in the requisite art will appreciate that the where the present invention is a system, a method, and/or a computer program product, the he computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Haskell, R, Clojure, javascript, C#, Swift, Lua, Pearl, Python, Ruby, or the like, and conventional procedural programming languages, such as the “C” programming language, object-oriented programming languages, functional programming languages or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The block diagrams in the illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments may be utilized in many different types of data processing environments. In order to provide a context for the description of the specific elements and functionality of the illustrative embodiments, are provided hereafter as example environments in which aspects of the illustrative embodiments may be implemented. It should be appreciated that are only examples and are not intended to assert or imply any limitation with regard to the environments in which aspects or embodiments of the present invention may be implemented. Many modifications to the depicted environments may be made without departing from the spirit and scope of the present invention.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying FIGS. do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those points, and by equivalents of such features.

What is claimed is:

1. A system for displaying linked inventory objects within a virtual venue map, the system comprising:
At least one database configured to store a plurality of data values corresponding to one or more event credentials, wherein at least one data values associated with each event credential includes a reference to one or more other event credentials that are linked to a given event credential and at least one data value provides a unique location identifier; and
a processor having a memory and configured by code to:
access the virtual venue map from one or more remote map servers, wherein each virtual map includes a plurality of unique location elements;
associating each of event credential with one of the plurality of unique location elements;
identifying each event credential that is linked to another access credential;
generating a visual marker that identifies each linked group of event credentials.

2. The system of claim 1, where the processor is configured to:
Unlink one event credential from one or more linked event credentials.

3. The system of claim 2, wherein unlinking includes:
accessing the location of a first linked event credential, spatial relationship between the first linked event credential and at least a second linked event credential,
determining, where the first linked event credential is linked only to at least second one event, and where the at least second linked credential is, in turn linked to at least one third linked credential, and
Based upon the determination, unlinking the first linked credential from the second linked credential.

4. The system of claim 2, wherein unlinking includes:
receiving a timing threshold,
evaluating the event data feature associated with the event credential, to determine if the time to event is within the event threshold; and where the event is within the event threshold,
unlinking each of the linked event credentials.

5. The system of claim 1, where the processor is configured to:
receive a selection request from a remote device, where the selection request includes reference to one or more unique location identifiers of the virtual map, and
alter the visual marker for each unique location identifier contained within the request and each unique location identifier that is linked a unique identification location referenced in the received request.

6. The system of claim 1, wherein the plurality of data values includes data corresponding to the location of each event credential of the plurality of event credentials.

7. A method of displaying linked inventory objects within a virtual venue map, the method comprising:
accessing, using a processor having a memory and configured by code a virtual venue map from one or more remote map servers, wherein each virtual map includes a plurality of unique location elements;
receiving, from a database, a plurality of data values corresponding to one or more event access credentials, wherein at least one data values associated with each event access credential includes a reference to one or more other event access credentials that are linked to a given event access credential and at least one data value provides a unique location identifier;
associating each of access credential with one of the plurality of unique location elements; and
identifying each access credential that is linked to another access credential; and generating a visual marker that identifies each linked group of access credentials.

8. The method of claim 1, further comprising:
receiving a selection request from a remote device, where the selection request includes reference to one or more unique location identifiers of the virtual map, and
altering the visual marker for each unique location identifier contained within the request and each unique location identifier that is linked a unique identification location referenced in the received request.
